(19) United States
(12) Patent Application Publication
(10) Pub. No.: US 2015/0319493 A1
(43) Pub. Date: Nov. 5, 2015

(54) Facilitating Commerce Related to Streamed Content Including Video

(71) Applicant: Intuitive Context Media, LLC, Saint Johns, FL (US)

(72) Inventor: Christopher Lynch, Saint Johns, FL (US)

(73) Assignee: Intuitive Context Media, LLC, Saint Johns, FL (US)

(21) Appl. No.: 14/500,098

(22) Filed: Sep. 29, 2014

Related U.S. Application Data
(60) Provisional application No. 61/988,499, filed on May 5, 2014.

(51) Int. Cl. H04N 21/442; H04N 21/4782; H04N 21/472; H04N 21/4786; H04N 21/81; H04N 21/482

(52) U.S. Cl. CPC H04N 21/44222; H04N 21/812; H04N 21/482; H04N 21/47217; H04N 21/4786; H04N 21/4782

(57) ABSTRACT

Consumers increasingly watch television, film, music videos and other video content and access textual material via the Internet, dedicated streaming services and platforms, and other on-demand-type services, thereby reducing or eliminating their exposure to commercials or other conventional advertisement. Aspects of the present disclosure provide mechanisms to introduce relevant, timely, contextual advertising and conduits for commerce transactions within on-demand-type content delivery systems.

### CROSS REFERENCE TO RELATED APPLICATION

This application claims priority to pending U.S. Provisional Patent Application No. 61/988,499, titled “Facilitating Commerce Related to Streamed Content Including Video,” filed on May 5, 2014, which is hereby incorporated by reference in its entirety.

### FIELD OF THE DISCLOSURE

The present disclosure generally relates to advertising associated with digital media content and more particularly to marketing to users of digital media content including streaming content.

### BACKGROUND

The statements in this section merely provide background information related to the present disclosure and may not constitute prior art.

The twenty-first century has seen a sea change in the way individuals consume mass media. Many people now watch at least some television programs and films on devices other than traditional televisions. Increasingly, people consume video content on mobile devices such as tablet computers, smartphones, as well as computers and laptops. Many people have eliminated home or office delivery of paper newspapers or magazines and instead view digital versions of newspapers or magazines. A growing number of households do not have cable. Rather, via high speed internet connections, they stream content over the internet from digital media sources including video on demand or short form video services. Streaming content is viewed on mobile devices, computers, and on televisions via standalone media players, internal Internet connectivity components and the like. Crucially, digital media content, including video on demand (VOD), short form video (SFV), and music video (MV) services reduce or completely eliminate the consumer's exposure to traditional commercials and other forms of advertising, disrupting the traditional revenue models of content providers, cable companies and the like.

VOD services enable the user to be very picky about what they choose to watch. For example, because a user has near instant access to decades of programming, their desire to watch newly produced content may be lessened. Because the user watches older content, or the same content over and over again, they are less likely, compared to an individual watching cable television, to be exposed to product placement within newly released content. This reduces the value of product placement in new content.

Many households which have a cable subscription rely heavily on set top digital video recorder (DVR) devices. A DVR is a device that records live television programming for later consumption. A user may record a program via a DVR and watch it at a later time. Typically, the user will fast forward through portions of the program they are not interested in, such as the commercials. This behavior closes another avenue of delivering advertisements to the consumer, even where they have cable.

The lack of effective marketing channels associated with video content is an especially critical problem because watching television and films is done by virtually every demographic. The key demographic for television viewers are younger, more affluent individuals but this demographic is the most likely to consume content in non-traditional, advertisement-free ways described above, making them harder to access.

In order to address the lack of effective marketing delivered via VOD and SFV services, service providers have resorted to popup advertising, side bar banner ads, enforced commercial breaks in the midst of content, and other obtrusive methods of delivering advertising to the digital consumer. These methods do not address individuals using paid VOD services or other ad-free services. Furthermore, people have become increasingly numb to such forms of advertisement, often ignoring them or otherwise tuning them out. Such advertisements often have little if any correlation to the subject matter of the content chosen by the viewer (L e., the video itself).

Given the foregoing, what is needed are new approaches to delivering marketing and advertising to consumers of digital media content. Specifically, new ways of marketing, advertising and facilitating sales to consumers of digital media content, including streaming content, VOD content, and SFV is needed.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Consumers increasingly watch television, film, music videos, and other video content and read newspapers, magazines and other textual content via the Internet, dedicated streaming services and platforms, and other on-demand-type services, thereby reducing or eliminating their exposure to commercials and other forms of advertising traditionally associated with programming provided by a network, cable provider, other inline media delivery system, and the like. In particular, according to Nielsen Media Research, in 2013 57.1 billion music videos were streamed, out of a total of 118 billion total streams. Additionally, consumers have become desensitized to web-based advertisements such as banner ads, popups, and the like. Some users also employ ad blocker programs within their web browser in order to prevent display of advertisements. In sum, consumers increasingly consume digital media content including video content via streaming and other services (e.g., VOD, SFV) and advertising opportunities are harder and harder to come by.

Providing relevant, contextual and timely advertising to consumers is considered less offensive and obtrusive and is more likely to be processed positively by consumers who are desensitized to traditional advertisements. Such advertising often results in higher click through and purchase conversion rates, compared to traditional advertisements.

Aspects of the present disclosure meet the above-identified needs by providing systems, methods, and computer program products which facilitate marketing to consumers of digital media content. Specifically, in an aspect, systems, methods, and computer program products are disclosed wherein contextual marketing information is presented to a user of digital media content in an integrated and unobtrusive manner. In an aspect, systems, methods, and computer program products are disclosed which facilitate marketing to consumers of VOD, SFV, MV, and other streamed content. In an aspect, systems, methods, and computer program products are disclosed which facilitate marketing to consumers of electronic magazines, electronic newspapers and other text based content. In an aspect, systems, methods, and computer program products are disclosed wherein contextual marketing information including contextual purchase opportunities and other advertisements are presented to a streaming video content consumer. In an aspect, one or more advertisements or purchasing opportunities are presented to the user when the user, from within a digital media platform, such as a streaming video platform, prompts a contextual commerce system to provide the opportunities. The information provided is relevant to the content the user has selected. That is, if the user selects a James Bond film, links to purchasing the soundtrack, the suits worn by James Bond, the cars driven, and the like may be provided. In this manner, relevant, contextual and timely advertising occurs. Users are provided purchasing opportunities that are directly tied to the content they are watching, are about to watch, or have previously watched, increasing the likelihood of impulse buying because the user just heard a song they like or just viewed their favorite character accomplish something while wearing appealing athletic shoes.

In an aspect, systems, methods, and computer program products are disclosed wherein contextual marketing information including contextual purchase opportunities and other advertisements are presented to an online magazine or newspaper user. In an aspect, one or more advertisements or purchasing opportunities are presented to the user when the user, from within an online magazine or newspaper, prompts a contextual commerce system to provide the opportunities. The information provided is relevant to the content the user has selected. That is, if the user selects an online sports article, links to purchasing tickets to future games featuring a team in the article, the replica jersey worn by the star player, travel to upcoming games, and the like may be provided.

In an aspect, from a computing device, a user navigates to a digital media content site and views a user interface. The user selects digital media content such as a television show, film, music video or other programming and is presented with information about the content, including an option to access the content (e.g., watch the show) and an additional information option, such as a “more information” or “go deeper” button. When the user selects the additional information option, the user is presented with a menu of contextual categories such as categorized contextual commerce and informational opportunities relevant to the selected digital media content including, but not limited to, “Merchandise,” “Fashion,” “Publishing,” “Travel” and “Music.” The user can purchase products, services, or other commerce utilized in the content of the digital media content. Such information is pulled from a contextual commerce database. The database contains information about the digital media content including television and films and is accessed when the user selects the additional information option. Additionally, product placement advertisement and other native advertising can be leveraged and the related commerce is facilitated. Links to purchase products that were specifically placed within the digital media content, such as a name brand watch or a vehicle, can be provided by aspects of the present disclosure.

In an aspect, the contextual marketing information is provided to a user of digital media who has previously used or accessed digital media content (also referred to a past user). Users are provided contextual marketing information that is related to the content they have previously accessed. Contextual marketing information is provided to the user via an email to the user or via the user's web browser, for example. The contextual marketing information can take any of a number of forms, for example an opinion poll asking how the user liked the previously accessed digital media content, a question, an invitation to receive additional information on the previously accessed digital media content, or other contextual marketing information. In an aspect, user input on the contextual marketing information prompts a contextual commerce system to provide contextual categories related to the digital media content previously accessed to the user. In an aspect, ad retargeting software (e.g., AdStage, DoubleClick) may be used. The user can select a contextual category and receive additional contextual marketing information, as described herein.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating providing contextual advertising to users within a video player platform, according to an aspect of the present disclosure.

FIG. 2 is a screenshot of an exemplary video-on-demand service user interface, according to an aspect of the present disclosure.

FIG. 3 is a screenshot of an exemplary dialog box presented to a user when the user selects a program from within a video-on-demand service, the dialog box including a “more” button which accesses a contextual advertising service, according to an aspect of the present disclosure.

FIG. 4 is a dataflow diagram for facilitating presenting contextual advertising to a user within a video-on-demand service, according to an aspect of the present disclosure.

FIG. 5 is a flowchart illustrating an exemplary process for providing a user with contextual advertising and facilitating a transaction based on the provided contextual advertising, according to an aspect of the present disclosure.

FIG. 6 is a flowchart illustrating an exemplary process of a user's experience in utilizing a VOD service having a contextual advertising component, according to an aspect of the present disclosure.

FIG. 7 is a block diagram of an exemplary computing system useful for implementing aspects of the present disclosure.

### DETAILED DESCRIPTION

The present disclosure is directed to systems, methods, and computer program products that facilitate content sharing coupled with a producer-designated physical asset.

Aspects of the present disclosure facilitate marketing to users of digital media content. In an aspect, digital media content is one or more of: streamed content, video, software, audio, VOD, SFV, online magazine, online newspaper, and social media. Aspects of the present disclosure facilitate marketing to consumers of streamed content, video, software, audio, VOD, SFV, online publication, online magazine, online newspaper and social media content. Aspects of the present disclosure facilitate marketing to users of VOD, SFV, MV, and other streamed content. Aspects of the present disclosure facilitate to marketing to consumers of online publications or other traditionally text based media, including online magazines and online newspapers.

Aspects of the present disclosure provide contextual marketing information to a user of digital media content. A user is also a consumer, where the digital media content is being consumed. A user can be actively interacting with the digital media content at least some of the time, such as participating in a video game, or passively interacting by watching or listening to the digital media content or having the digital media content run in the background.

Contextual marketing information is related to the digital media content. Contextual marketing information can take any of a number of forms, as will be appreciated by persons skilled in the relevant art(s) after reading the disclosure. In an aspect, contextual marketing information includes one of: an opportunity to purchase products or services; information; and an advertisement. In an aspect, contextual marketing information is the opportunity to purchase products or services such as merchandise related to the digital media content, including, but not limited to apparel or other products having a logo or title appearing in the digital media content (name of the music group or sports team, for example). In an aspect, contextual marketing information is the opportunity to download songs or videos appearing in the digital media content or related to the digital media content, such as the next episode of a show. In an aspect, contextual marketing information is the opportunity to purchase a copy of the digital media content or related digital media content. In an aspect, contextual marketing information is the opportunity to receive a promotion related to the digital media content (such as an opportunity to purchase travel to locations shown in the digital media content, a discount to be applied to a purchase of the next season of a show or the next issue of an online magazine, for example).

In an aspect, contextual marketing information is an opportunity to purchase a product placed in the digital media content, such as a computer or other electronic device seen in the digital media content; clothing worn by an actor or athlete; food or beverages appearing in the digital media content; a car used by an actor; or other such product placement. In an aspect, contextual marketing information is information about the digital media content, such as a list of actors appearing in the digital media content; more information about the production of the digital media content; information about the locations seen in the digital media content; outtakes; or other information. In an aspect, contextual marketing information is an advertisement about a product or service or information related to the digital media content. In an aspect, contextual marketing information includes one of: an opinion poll; a query and an invitation to receive information.

In an aspect, contextual marketing information can be accessed using contextual categories. In an aspect, contextual categories are pre-selected based on the digital media content. In an aspect, contextual categories are stored in a database. In an aspect, contextual categories include one or more of: Fashion; Travel; Merchandise; Memorabilia; Social Conversation; Publishing; Music; More Information; and Promotions.

In an aspect, contextual marketing information is presented to the user when the user, from within the digital media content platform, prompts a contextual commerce system to provide the opportunities. Advertisements or purchasing opportunities for products placed within the digital media content via native advertising or product placement, or situational aspects of the digital media content, such as opportunities to purchase travel to the location in the digital media content may also be presented to the user. In some aspects, systems, methods, and computer program products present contextual purchase opportunities and other advertisements to a streaming video content user in an unobtrusive manner from within a streaming video, VOD, SFV, MV, or other service.

In an aspect, users are provided contextual marketing information, including purchasing opportunities, that is directly tied to the content they are accessing, are about to access or have previously accessed. In an aspect, users are provided contextual marketing information that is directly tied to the content they are watching, are about to watch or have previously watched. In an aspect, users are provided contextual marketing information that is directly tied to the content they are reading, are about to read or have previously read.

In some aspects, systems, methods, and computer program products present contextual purchase opportunities and other advertisements to a user of digital media content from within a video, software, audio, VOD, SFV, online publication, online magazine, online newspaper, social media, or other service.

In an aspect, a user input, selection or request of a contextual category or other aspect of the disclosure may be made in a number of ways, including use of a radio button configured to accept a selection by being clicked on with a cursor (or tapped) or in other ways; clicking or tapping in a designated area on various electronic forms such as the use of a check box or other user-selectable icon. Any configuration or manner of selecting, inputting or requesting apparent to those skilled in the relevant art(s) after reading the description herein may be utilized.

In an aspect, a user input, selection or request results in the creation of a connection to a third party website through any of a number of means, known to one of ordinary skill in the relevant art(s). For example, a web server running a server application at a Web site which sends out Web pages in response to Hypertext Transfer Protocol (HTTP) or Hypertext Transfer Protocol Secured (HTTPS) requests from a remote browser can be used to create a connection to a third party website.

In an aspect, provided is a computer-implemented method for providing contextual marketing information to a user of digital media content, comprising the steps of: providing a user interface overlay on a digital media site, the user interface overlay associated with digital media content presented by the digital media site; receiving, via the user interface overlay, a user input requesting contextual marketing information from the user interface overlay; providing information about the digital media content to a service provider application programming interface; receiving contextual categories from the service provider application programming interface, wherein the contextual categories are generated by the service provider application programming interface and the contextual categories are in part based on the digital media content associated with the contextual marketing information within a contextual commerce database; providing contextual categories to the user; receiving a user selection of a contextual category; and presenting to the user, via the user interface overlay, the contextual marketing information associated with the selected contextual category. In an aspect, the method further comprises the step of providing a record of a transaction related to the contextual marketing information to the service provider application programming interface, the transaction executed by the user. In an aspect, the contextual marketing information associated with the selected contextual category is provided through connection to a third party website. The third party website can include a delivery agent, EBay, Twitter, Expedia, a web browser, Amazon, or other third party websites associated with the selected contextual category. As described elsewhere herein, in an aspect, the contextual marketing information includes one of: an opportunity to purchase products or services; information; and an advertisement.

In various aspects of the disclosure, information about the user is utilized for various purposes. For example, in an aspect, information about the user is provided to the service provider application programming interface and the contextual categories generated are in part based on the provided user information. User information can be the user's gender, for example, for use in generating contextual marketing information which is considered more relevant to a particular gender than another. User information can be the user's age group, for use in generating contextual marketing information which is considered more relevant to a particular user age group. User information can be the geographical area where the user is located, for example, for use in generating geographical contextual marketing information such as offers for stores or restaurants in the user's geographical area. Other types of user information and the utilization of this user information will be known to one of ordinary skill in the relevant art(s) after reading the current disclosure. These types of user information and the utilization thereof are intended to be included in this disclosure.

In an aspect, a third-party database is used in the methods, systems and computer program products disclosed herein. In an aspect, the third-party database contains the digital media content. In an aspect, the third party database contains data about contextual commerce opportunities associated with the digital media content, such as product placement opportunities found in the digital media content, more information about the digital media content, and other contextual marketing information as described herein. In an aspect, the third party database contains the contextual categories associated with digital media content. In an aspect, the third party database contains user information.

In an aspect, the service provider application programming interface is cloud-based. The use of cloud-based technology and implementation thereof is known to one or ordinary skill in the relevant art(s) without undue experimentation and the use thereof is incorporated into the disclosure.

Also disclosed in an aspect is a computer-implemented method, system and computer program product for providing contextual marketing information to a past user of digital media content. In this aspect, at some time after the user has consumed digital media content, contextual marketing information is presented. In an aspect, information about the digital media content the user previously accessed and information about the user (including, for example, the user's email address or IP address) is provided to a service provider application programming interface. Contextual marketing information is received from the service provider application programming interface and provided to the user. This contextual marketing information is in part based on the digital media content and in part based on the provided user information. In an aspect, the contextual marketing information is one of: an opinion poll; a query; and an invitation to receive information. As an example, the contextual marketing information can be a query, such as “Did you like MIB3?”. As another example, the contextual marketing information can be an opinion poll, such as “Please tell us who the number one star was of last night's Gators game.” As a further example, the contextual marketing information can be an invitation to receive information, such as “Do you want to learn more about the next episode of Breaking Bad?” Other examples of contextual marketing information will be apparent to one of ordinary skill in the relevant art(s). The contextual marketing information can be provided to the past user of digital media content in a number of ways known to one of ordinary skill in the relevant art(s), such as via an email or via the user's web browser. Once the user has provided a selection or input from the contextual marketing information, the service provider application programming interface is contacted and contextual categories are generated. The contextual categories are in part based on the digital media content associated with the contextual marketing information within a contextual commerce database. A user interface overlay containing the contextual categories received from the service provider application programming interface is provided to the user, who selects a contextual category and contextual marketing information associated with the selected contextual category is presented to the user via a user interface overlay. A record of a transaction related to the contextual marketing information, the transaction executed by the user, can also be provided to the service application programming interface, in an aspect.

Also disclosed is a computer system for providing contextual information to a user of digital media content, comprising: at least one application server capable of providing a user interface overlay, via a communications network, to a computing device, the computing device configured to communicate with a user of digital media content; at least one contextual commerce database comprising contextual categories related to the digital media content, the contextual commerce database communicatively coupled to the at least one application server via the communications network; a processor disposed in communication with the application server, wherein the processor is programmed to perform: receiving a request for contextual marketing information from a computing device; receiving metadata associated with the digital media content; communicating the metadata regarding the digital media content to the contextual commerce database via the communications network; receiving contextual categories from the contextual commerce database, wherein the contextual categories are in part based on the metadata associated with the digital media content; overlaying a user interface overlay containing the contextual categories on the computing device; receiving a user input of a contextual category; connecting the computing device to a website associated with the contextual category. In an aspect, the system further comprises at least one third-party database, communicatively coupled to the at least one application server via the communications network, the third-party database containing at least one of: the digital media content; metadata about contextual commerce opportunities associated with the digital media content; and metadata about the user. In an aspect, information about the user is received by the processor, wherein the contextual categories are in part based on the received user information.

Also disclosed is a computer readable storage medium for storing computer readable instructions for providing contextual marketing information to users of digital media. In an aspect, the computer readable instructions comprises logic configured to present a user interface overlay on a digital media site; logic configured to receive a user input requesting information from the user interface overlay; logic configured to generate contextual categories; logic configured to present contextual categories to the user; logic configured to receive a user selection of a contextual category; and logic configured to direct the user to the information associated with the contextual category. In an aspect, the computer readable storage medium further comprises logic configured to receive a record of a transaction related to the contextual marketing information. In an aspect, the computer readable storage medium further comprises logic configured to access a third party database to generate the contextual categories.

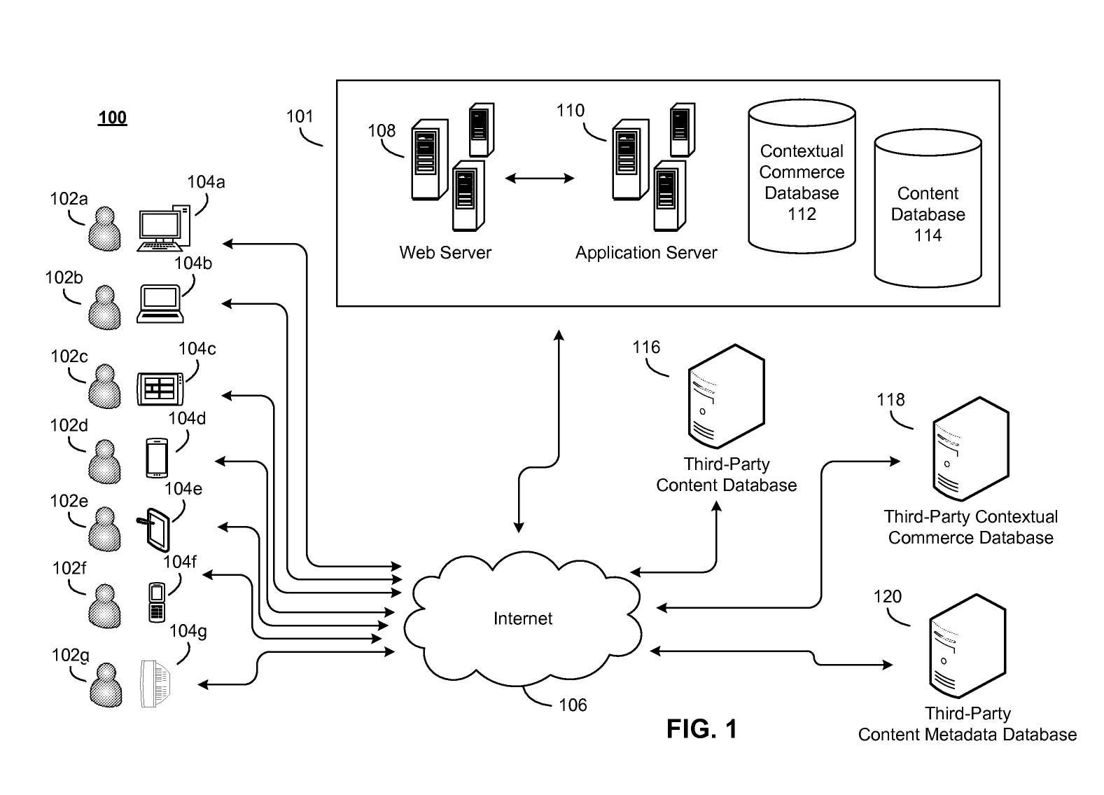

Referring now to FIG. 1, a block diagram of an exemplary system for facilitating content sharing coupled with a producer-designated physical asset, according to an aspect of the present disclosure, is shown.

Cloud-based, Internet-enabled device communication system 100 includes a plurality of users 102 (shown as producers 102a-g in FIG. 1) accessing via a computing device 104 (shown as respective computing devices 104a-g in FIG. 1) and a network 106, such as the global, public Internet an application service provider's cloud-based, Internet-enabled infrastructure 101.

User 102 may access infrastructure 101 in order to watch video content or consume other digital media content. Video content includes, but is not limited to, television programming, film, music videos, VOD services, SFV services, DVR recordings, and the like. Digital media content includes, but is not limited to, streamed content, video, software, audio, VOD, SFV, online publication, online magazine, online newspaper and social media content. User 102 may also access infrastructure 101 to facilitate a commercial transaction such as buying digital media content such as music or video content, or buying merchandise and the like. System 100 may be used to purchase, among other things, fashion, travel, merchandise, memorabilia, publishing, music and promotions. System 100 may also be used to display social media conversation related to the content presented to user 102.

In various aspects, computing device 104 may be configured as: a desktop computer 104a; a laptop computer 104b; a tablet or mobile computer 104c; a smartphone (alternatively referred to as a mobile device) 104d; a Personal Digital Assistant (PDA) 104e; a mobile phone 104f; a television (e.g., a television equipped with network connectivity and VOD applications, a television connected to a DVR service or apparatus) 104g; any commercially-available intelligent communications device; or the like.

An application service provider's cloud-based, communications infrastructure 101 may include one or more web servers 108, one or more application servers 110, a contextual commerce database 112, and a content database 114. In various aspects, content database 114 and contextual commerce database are not contained within infrastructure 101. Infrastructure 101 may access one or more of a third-party content database 116, a third-party contextual commerce database 118 and a third-party content metadata database 120. Infrastructure 101 may use such third-party databases to replace and/or augment the internal databases of infrastructure 101. Infrastructure 101 may further include communications gateways such as an email gateway, an instant messaging gateway and the like.

Contextual commerce database 112 contains metadata about content provided to users 102. Content may be provided by infrastructure 101 or by a third party service, such as a VOD or SFV service. For example, contextual content database 112 contains information about all the products, or a selection of products, including products inserted via product placement, used in a specific movie as well as links to websites where the products may be purchased. In another example, contextual content database 112 contains information about situational aspects of the digital media content, such as travel locations, used in the digital media content as well as links to websites where travel packages to the locations may be purchased. Database 112 may also contain information identifying all the music used in the movie as well as links to websites where the music may be purchased. Similarly, database 112 may contain information related to promotional merchandise for the film. As will be apparent to those skilled in the relevant art(s) after reading the description herein, database 112 may contain commerce opportunities, information about portions of the content, and other information about other financial and non-financial opportunities related to the content. Each video or other content available via system 100 may have a related contextual commerce file or listing within contextual content database 112.

Content database 114 is configured to store content streamed or otherwise presented to user 102. In an aspect, content database 114 or third-party content database 116 contain all the titles available for streaming by a given VOD service. In another aspect, content database 114 contains pointers or other indicators of where content may be called from in order to present it to user 102.

In some aspects, system 100 comprises third-party metadata database 120. Database 120 may contain information indicating the origin of all, or a portion of, all the goods and services depicted in a variety of television programs and films. Database 120 may be accessed by infrastructure 101 in order to identify advertising opportunities. After identifying such opportunities via database 122, infrastructure 101 may then access retailer databases in order to identify where user 102 may purchase such goods or services.

As will be appreciated by those skilled in the relevant art(s) after reading the description herein, in such an aspect, an application service provider an individual person, business, or other entity may allow access, on a free registration, paid subscriber and/or pay-per-use basis, to infrastructure 101 via one or more World-Wide Web (WWW) sites on the Internet 108. Thus, system 100 is scalable.

As will also be appreciated by those skilled in the relevant art(s), in an aspect, various screens would be generated by server 108 in response to input from users 102 over Internet 106. That is, in such an aspect, server 108 is a typical web server running a server application at a website which sends out webpages in response to Hypertext Transfer Protocol (HTTP) or Hypertext Transfer Protocol Secured (HTTPS) requests from remote browsers on various computing devices 104 being used by various users 102. Thus, server 108 is able to provide a graphical user interface (GUI) to users 102 of system 100 in the form of, for example, webpages. These webpages are sent to the user's PC, laptop, mobile device, PDA, television, tablet or like device 104, and would result in the GUI being displayed.

As will be appreciated by those skilled in the relevant art(s) after reading the description herein, alternate aspects of the present disclosure may include providing a tool for facilitating content sharing coupled with a producer-designated physical asset to devices 104 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where users 102 are all personnel/employees of the same company, the present disclosure may be implemented as a stand-alone system, rather than as a web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating content sharing coupled with a producer-designated physical asset via infrastructure 101 and devices 104 via a browser or operating system pre-installed with an application or a browser or operating system with a separately downloaded application on such devices 104. That is, as will also be apparent to one skilled in the relevant art(s) after reading the description herein, the application that facilitates the content sharing platform herein, may be part of the “standard” browser or operating system that ships with computing device 104 or may be later added to an existing browser or operating system as part of an “add-on,” “plug-in,” or “app store download.”

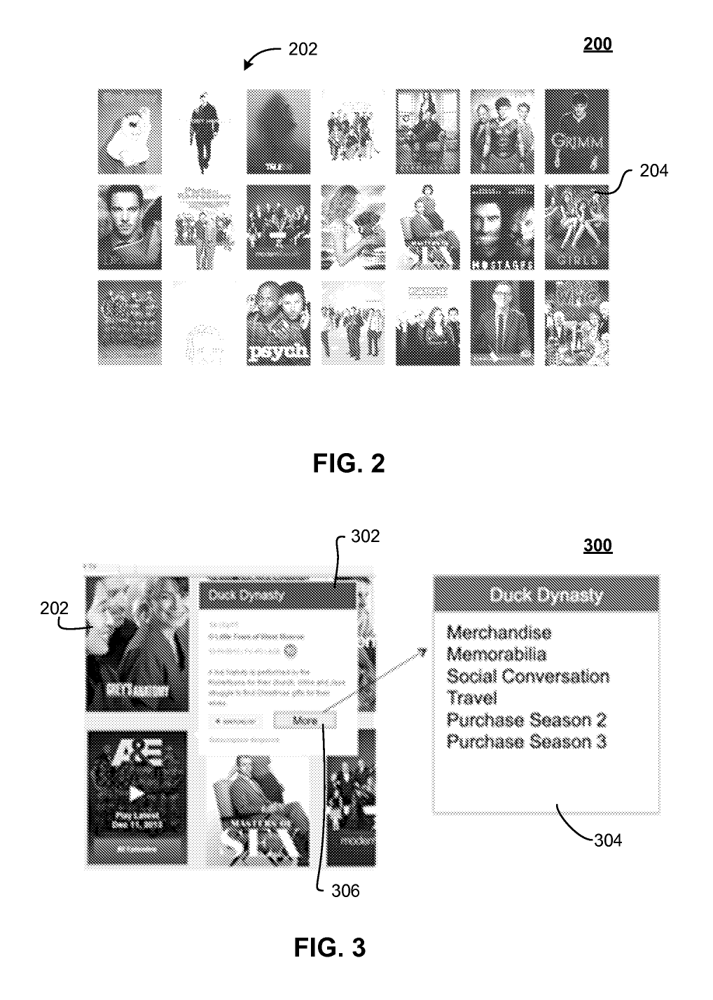

Referring now to FIGS. 2 & 3, screenshots 200, 300 of an exemplary video-on-demand service user interface, according to an aspect of the present disclosure, are shown. Screenshot 300 shows an exemplary dialog box 302 presented to user 102 when user 102 selects program icon 202 from within a video-on-demand service, dialog box 302 including a “more” button 306 which accesses a contextual advertising service and presents a contextual advertising window 304 to user 102 via computing device 104.

In an aspect, from a computing device, a user navigates to a VOD site and views a user interface 204. User 102 selects a television show by clicking on the associated icon 202 and is presented with information about the show via dialog box 302, including an option to watch the show and an additional information option, such as a “more information” or “go deeper” button 306. When user 102 selects the additional information option 306, user 102 is presented with a menu 304 which links to commerce opportunities and informational sites relevant to the selected program such as links to websites where user 102 can purchase clothing, furniture, or other items utilized in the program, information about the setting of the program, links where user 102 can purchase music played during the program, and the like. As will be apparent to those skilled in the relevant art(s) after reading the description herein, such information and opportunities may be presented in any discernible format and is not limited to a text-based list. Such information is pulled from contextual commerce database 112 and/or third-party databases. Presentation of such relevant contextual commerce opportunities is done in a polite and intuitive fashion. Furthermore, presenting advertisements and/or commerce opportunities in this manner provides viewers of VOD, SFV, and MV content a customized avenue for additional engagement with the programming. System 100 and the present disclosure enables marketing to users 102 during binge watching of VOD and other streaming content. The viewers are able to surround themselves with the programming they crave and go as deep as they wish into related content, while not being interrupted by traditional obtrusive commercials.

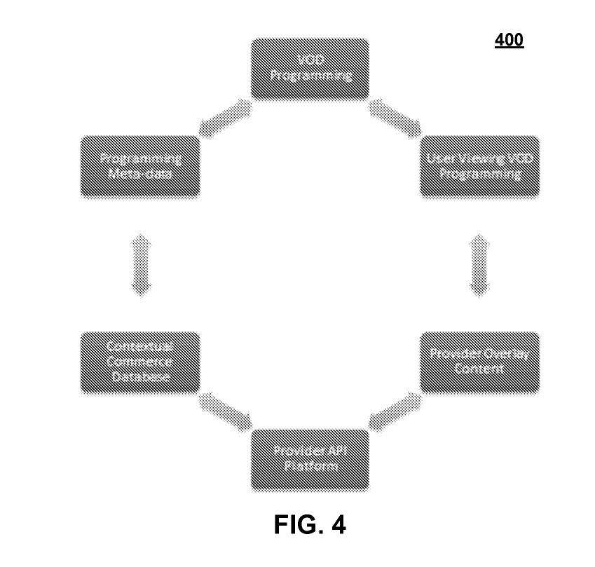

Referring now to FIG. 4, a dataflow diagram 400 for facilitating presenting contextual advertising to user 102 within a video-on-demand service, according to an aspect of the present disclosure, is shown.

In order to provide contextual commerce opportunities and other forms of polite advertising and information to user 102, metadata about VOD programming must be provided. The metadata must be accessible and relatable to information in a contextual commerce database. The contextual commerce database may be constructed based on the information contained in a metadata database. The metadata and the contextual commerce information is accessed by infrastructure 101, such as an ASP application programming interface (API) or another platform and overlayed on or otherwise integrated with the content or user interface of the VOD service, thereby allowing user 102 to access the contextual commerce information before, during, or after playback of content.

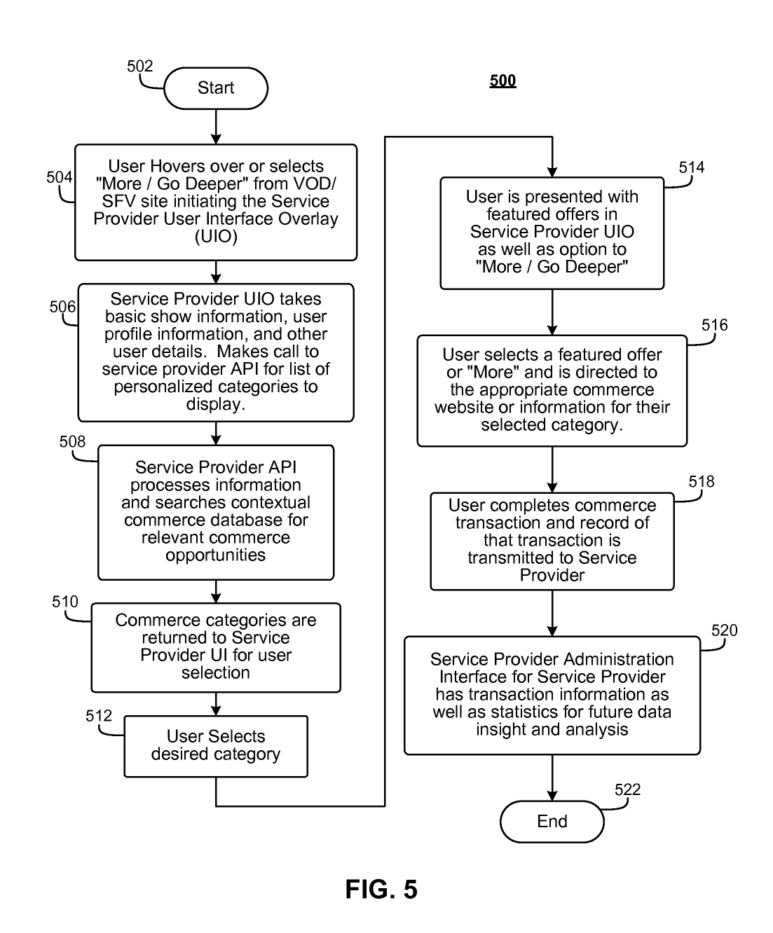

Referring now to FIG. 5, a flowchart illustrating an exemplary process 500 for providing user 102 with contextual advertising and facilitating a transaction based on the provided contextual advertising, according to an aspect of the present disclosure, is shown.

Process 500, which may execute within system 100 and facilitate a commercial transaction (e.g., purchasing fashion, travel, merchandise, memorabilia, publishing, music or promotions), begins at step 502 with control passing immediately to step 504.

At step 504, user 102 visiting a streaming service or other VOD provider accesses contextual commerce options by selection more information button 306 associated with selected content (e.g., a TV show). This initiates an ASP user interface overlay (UIO) via infrastructure 101, such as window 304. In some aspects, the UIO is presented as a sidebar or in another position away from the content being viewed or other information presented to user 102. In another aspect, the UIO is presented on another computing device 104 such as a tablet computing device when user 102 is utilizing a television to watch the associated content.

At step 506, infrastructure 101 accesses information about the selected content and uses the accessed information to call a list of categories of information related to the selected content for display to user 102.

At step 508, information is returned from a contextual commerce database 112, 118, providing information about relevant commerce opportunities. Such opportunities may be based on a particular scene in the content, the overall theme of the content, or have another connection that will be apparent to those skilled in the relevant art(s) after reading the description herein.

At step 510, user 102, via the UIO, is presented with commerce categories returned in step 506. User 102 selects a category in step 512 and is presented with advertisements returned in step 508 at step 514. User 102 may also be presented with a “more” option, enabling the viewing of additional advertisements or commerce opportunities.

At step 516, user 102 selects a commerce opportunity and is routed to a website or other portal where the transaction may be completed.

At step 518, the transaction is completed between, for example, a third-party retailer and user 102. A record of the transaction is routed to the ASP of infrastructure.

At step 520, statistics about user 102 interaction with contextual content is stored for future analysis, data insight and commission reconciliation.

Process 500 terminates at step 522.

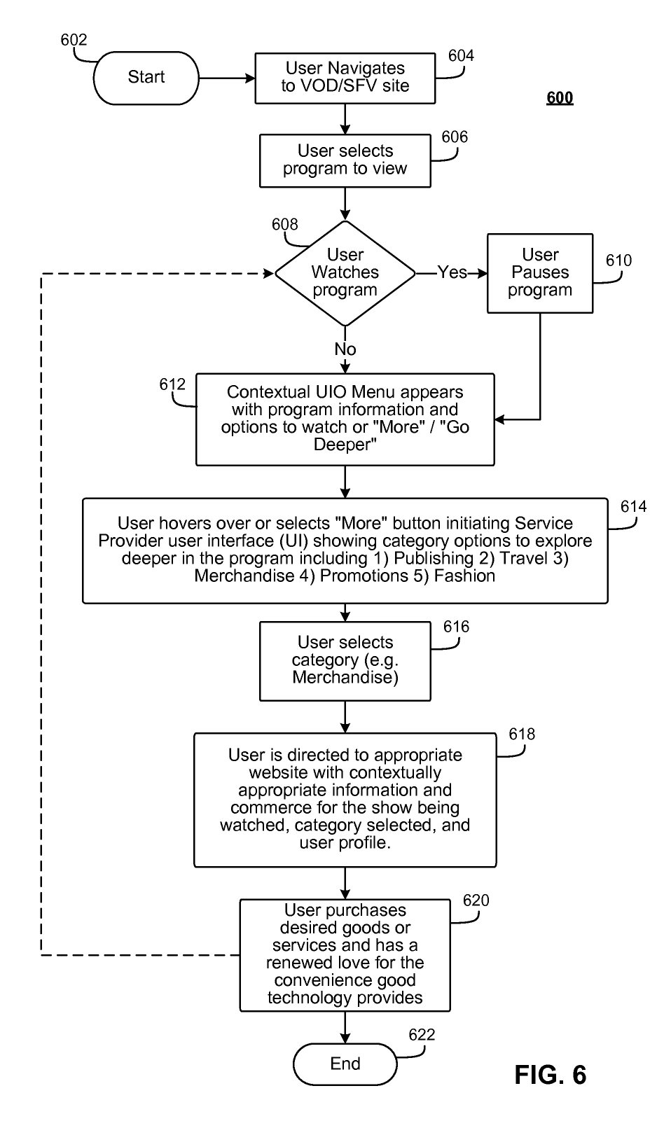

Referring now to FIG. 6, a flowchart illustrating an exemplary process 600 of user experience in utilizing a VOD service having a contextual advertising component within system 100, according to an aspect of the present disclosure, is shown.

Process 600, which may execute within system 100 and facilitate user 102 purchase via contextual advertising, begins at step 602 with control passing immediately to step 604.

At step 604, user 102 opens a streaming service, accesses a DVR, navigates to a VOD, SFV, or MV site or the like. User 102 is presented with a series of content choices and selects the content (e.g., a movie) to view at step 606.

At decision step 608, the user is presented with dialog box 302 and may choose to watch the selected content or to explore contextual information including advertising generated by infrastructure 101. If user 102 chooses to watch the content, process 600 proceeds to step 610. If user 102 foregoes watching the content, step 612 executes.

At step 610, user 102 pauses playback of the content and step 612 executes.

At step 612, a contextual menu is presented to user 102 via computing device 104 from infrastructure 101. The menu may be a version of dialog box 302 and contain a button or prompt to explore contextual information generated by infrastructure 101 such as additional information option 306.

At step 614, user 102 selects additional information option 306 by clicking the button or hovering over an area or another action. This prompts infrastructure 101 to present user 102 with several categories of information such as publishing, travel, merchandise, promotion, and fashion. As will be apparent to those skilled in the relevant art(s) after reading the description herein, presenting such categories may be omitted in some aspects.

At step 616, user 102 selects a category presented in step 614.

At step 618, a web browser or other component of on computing device 104 is directed to a website or other page corresponding with the category selection made in step 616. Relevant items for purchase may be shown in addition to information relevant to the content being watched and the category selected.

At step 620, user 620 selects one or more items for purchase and completes the transaction. User 102 may decide to continue watching the content, executing step 608, or process 600 may terminate at step 622.

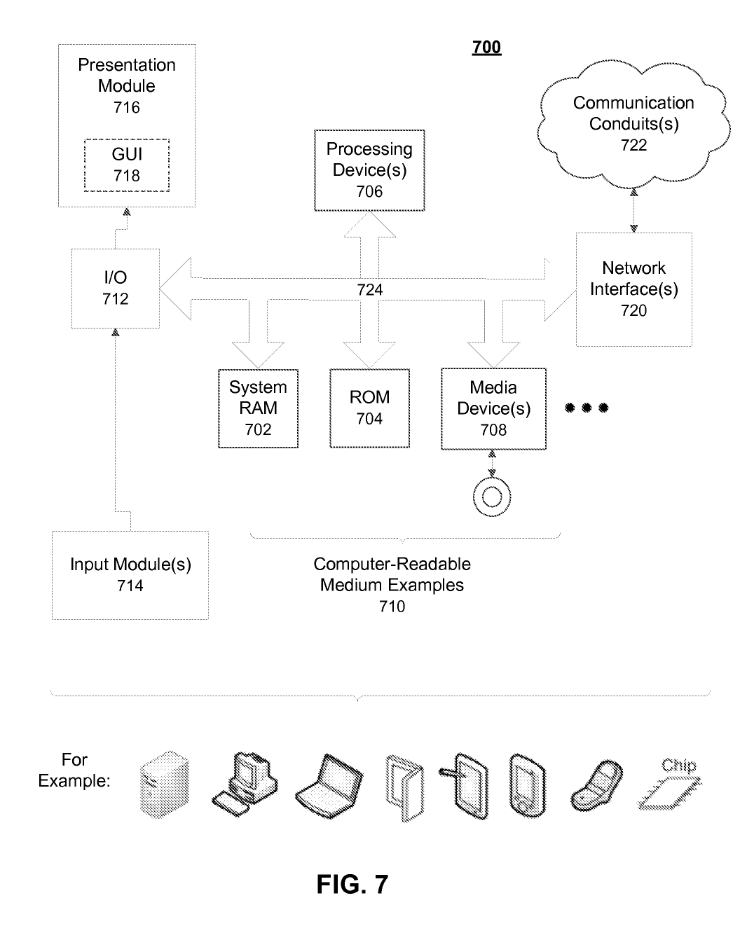

Referring now to FIG. 7, a block diagram of an exemplary computer system 700 useful for implementing various aspects the processes disclosed herein, in accordance with one or more aspects of the present disclosure, is shown.

That is, FIG. 7 sets forth illustrative computing functionality 700 that may be used to implement web server 108, application server 110, contextual commerce database 112, content database 114, third-party content database 116, third-party contextual commerce database 118, third-party content metadata database 120 computing devices 104, or any other component of system 100 (shown or not shown). In all cases, computing functionality 700 represents one or more physical and tangible processing mechanisms.

Computing functionality 700 may comprise volatile and non-volatile memory, such as RAM 702 and ROM 704, as well as one or more processing devices 706 (e.g., one or more central processing units (CPUs), one or more graphical processing units (GPUs), and the like). Computing functionality 700 also optionally comprises various media devices 708, such as a hard disk module, an optical disk module, and so forth. Computing functionality 700 may perform various operations identified above when the processing device(s) 706 execute(s) instructions that are maintained by memory (e.g., RAM 702, ROM 704, and the like).

More generally, instructions and other information may be stored on any computer readable medium 710, including, but not limited to, static memory storage devices, magnetic storage devices, and optical storage devices. The term “computer readable medium” also encompasses plural storage devices. In all cases, computer readable medium 710 represents some form of physical and tangible entity. By way of example, and not limitation, computer readable medium 710 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 702, ROM 704, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 700 may also comprise i/o module 712 for receiving various inputs (via input modules 714), and for providing various outputs (via one or more output modules). One particular output module mechanism may be a presentation module 716 and an associated GUI 718. Computing functionality 700 may also include one or more network interfaces 720 for exchanging data with other devices via one or more communication conduits 722. In some embodiments, one or more communication buses 724 communicatively couple the above-described components together.

Communication conduit(s) 722 may be implemented in any manner (e.g., by a local area network, a wide area network (e.g., the Internet), and the like, or any combination thereof). Communication conduit(s) 722 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

1. A computer-implemented method for providing contextual marketing information, to a user of digital media content at a digital media site (DMS), the method comprising the steps of:
(a) providing a user interface overlay on the DMS when hovering over a respective one program icon of a plurality of program icons displayed by a DMS user interface of the DMS, the user interface overlay overlaid on the DMS user interface and also providing a first option to receive a program associated with the respective one program icon and a second option to receive contextual marketing information associated with the respective one program icon, the user interface overlay associated with digital media content presented by the DMS;
(b) receiving, via the user interface overlay, a user input requesting the contextual marketing information from the user interface overlay;
(c) providing information about the digital media content to a service provider application programming interface;
(d) receiving contextual categories from the service provider application programming interface, wherein the contextual categories are generated by the service provider application programming interface and the contextual categories are in part based on the digital media content associated with the contextual marketing information within a contextual commerce database;
(e) providing, via the user interface overlay, contextual categories to the user;
(f) receiving a user selection of a contextual category; and
(g) presenting to the user, via the user interface overlay, the contextual marketing information associated with the selected contextual category;
wherein the contextual marketing information is chosen from vendor offerings provided by a plurality of vendors.

2. The method of claim 1, further comprising the step of:
(h) providing a record of a transaction related to the contextual marketing information to the service provider application programming interface, the transaction executed by the user; and
(i) providing a portion of the received commission to a digital media site operator, the digital media site operator operating the digital media site.

3. The method of claim 1, wherein the digital media content is one of: streamed content; video; software; audio; VOD; SFV; online magazine; online newspaper; and social media.

4. The method of claim 1, wherein presenting step (g) comprises connecting to a. third party website of one or the plurality of vendors.

5. The method of claim 1, wherein the contextual marketing information includes one of: an opportunity to purchase products or services; information; and an advertisement.

6. The method of claim 2, wherein providing step (c) further comprises providing information about the user to the service provider application programming interface, wherein the contextual categories in receiving step (d) are in part based on the provided user information.

7. The method of claim 1, further comprising:
(h) providing at least one third-party database, the database containing at least one of:
the digital media content; metadata about contextual commerce opportunities associated with the digital media content; and user information.

8. The method of claim 1, wherein the service provider application programming interface is cloud-based.

9. The method of claim 1, further comprising the steps of:
providing rnetadata about the digital media content the user previously accessed and information about the user to the service provider application programming interface;
receiving first contextual marketing information from the service provider application programming interface, wherein the first contextual marketing information is in part based on the digital media content and in part based on the provided user information;
providing the first contextual marketing information to the user.

10. The method of claim 9, wherein the first contextual marketing information is one of an opinion poll; a query; and an invitation to receive information.

11. The method of claim 9, wherein the user is a past user; and the first contextual marketing information is provided to the past user of digital media content via an email.

12. The method of claim 9, wherein the user is a past user; and the first contextual marketing information is provided to the past user of digital media content via the user's web browser.

13. (canceled)

14. (canceled)

15. A computer system for providing contextual marketing information to a user of digital media content from a digital media site (DMS) displaying on a DMS user interface a plurality of program icons, comprising:
(a) at least one application server capable of providing a user interface overlay, via a communications network, to a computing device, the computing device configured to communicate with the user of the digital media content;
(b) at least one contextual commerce database comprising contextual categories related to the digital media content, the contextual commerce database communicatively coupled to the at least one application server via the communications network;
(c) a processor disposed in communication with the application server, wherein the processor is programmed to perform:
i. receiving a request for contextual marketing information from the computing device via the user interface overlay when hovering over a respective one program icon of the plurality of program icons displayed by the DMS user interface of the DMS, the user interface overlay overlaid on the DMS user interface and also providing a first option to receive a program associated with the respective one program icon and a second option to receive the contextual marketing information associated with the respective one program icon;
ii. receiving metadata associated with the digital media content;
iii. communicating the metadata regarding the digital media content to the contextual commerce database via the communications network;
iv. receiving contextual categories from the contextual commerce database, wherein the contextual categories are in part based on the metadata associated with the digital media content;
v. overlaying a user interface overlay containing the contextual categories on the computing device;
vi. receiving a user input of a contextual category;
vii. connecting the computing device to a website associated with the contextual category presenting contextual marketing information;
wherein the application server is operated by a service provider; and
wherein the contextual marketing information is chosen from vendor offerings provided by the plurality of vendors.

16. The system of claim 15, further comprising at least one third-party database, communicatively coupled to the at least one application server via the communications network, the third-party database containing at least one of: the digital media content; metadata about contextual commerce opportunities associated with the digital media content; and metadata about the user.

17. The system of claim 15, wherein receiving step (iv) further comprises receiving information about the user, wherein the contextual categories are in part based on the received user information.

18. A non-transitory computer readable storage medium for storing computer readable instructions, the computer readable instructions for causing a computer to provide contextual marketing information to a user of digital media, the computer readable instructions comprising:
logic configured to display a plurality of program icons by a digital media site user interface in a digital media site (DMS);
logic configured to present a user interface overlay on the DMS when hovering over a respective one program icon of the plurality of program icons displayed by the DMS user interface, the user interface overlay overlaid on the DMS user interface and also providing a first option to receive a program associated with the respective one program icon and a second option to receive contextual marketing information associated with the respective one program icon;
logic configured to receive, via the user interface overlay, a user input requesting the contextual marketing information;
logic configured to generate contextual categories;
logic configured to present contextual categories to the user within the user interface overlay;
logic configured to receive a user selection of a contextual category; and
logic configured to, within the user interface overlay, present the user with contextual marketing information associated with the selected contextual category;
wherein the contextual marketing information is chosen from vendor offerings provided by a plurality of affiliated vendors.

19. The non-transitory computer readable storage medium of claim 18, further comprising:
logic configured to receive a record of a transaction related to the selected contextual marketing information.

20. The non-transitory computer readable storage medium of claim 18, further comprising:
logic configured to access a third party database to generate the contextual categories.
